(19) United States
(12) Patent Application Publication
(10) Pub. No.: US 2015/0172186 A1
(43) Pub. Date: Jun. 18, 2015

(54) NETWORK SYSTEM AND COMMUNICATION METHOD

(71) Applicant: NEC Corporation, Tokyo (JP)

(72) Inventor: Yoshiya KIZU, Tokyo (JP)

(73) Assignee: NEC Corporation

(21) Appl. No.: 14/570,002

(22) Filed: Dec. 15, 2014

(30) Foreign Application Priority Data
Dec. 18, 2013 (JP) 2013-261562

(51) Int. Cl. H04L 12/741

(52) U.S. Cl. CPC H04L 45/74

(57) ABSTRACT

A network system according to the present invention includes a switch configured to receive a packet from a terminal, to identify source information of the packet, to append the source information to the packet based on an instruction, and to transmit the packet, to which the source information is appended, to a communication path based on the instruction, and a controller configured to issue the instruction to the switch. Through this, communication source information, such as a user name, can be identified and the communication path can be specified for respective pieces of source information by referring to the communication from the terminal without introducing an additional device.

This application is based upon and claims the benefit of priority from Japanese Patent Application No. 2013-261562, filed on Dec. 18, 2013, the disclosure of which is incorporated herein in its entirety by reference.

### TECHNICAL FIELD

The present invention relates to a network system and a communication method in which a plurality of users use a system within an organization through a shared terminal.

### BACKGROUND ART

When using resources within an organization from a network outside the organization through the Internet, a plurality of users increasingly use a system within the organization through a shared terminal for a security measure or to reduce machine resources. When a plurality of users share a single terminal, it is difficult to identify which user establishes a certain communication originated at the terminal.

In particular, it is difficult to identify a user in anonymous communication, such as hypertext transfer protocol (HTTP) and file transfer protocol (FTP), in user datagram protocol (UDP) communication, such as network time protocol (NTP) and domain name system (DNS), or the like, that do not require user authentication.

When a security incident in which a terminal used by a plurality of users is infected with a worm or the like occurs, a problem arises in that a user who establishes a communication cannot be determined even by checking a server log and the like, and the cause cannot be tracked down. Therefore, for the security incident that occurs, an extreme measure such as stopping communication of the entire users is being taken.

To counter against the above-described problem, Japanese Patent Application Laid-open Publication No. 2001-44992 discloses a technique that makes it possible to uniquely identify a user who establishes a certain communication. Japanese Patent Application Laid-open Publication No. 2001-44992 discloses a technique in which user information is mounted for each communication at the time when a communication is established, by embedding dedicated software to devices provided on a network.

The technique disclosed in Japanese Patent Application Laid-open Publication No. 2001-44992, however, has the following problem. According to Japanese Patent Application Laid-open Publication No. 2001-44992, the user information is mounted for each communication at the time when a communication is established, by embedding dedicated software to devices provided on a network. In order to implement such a technique, however, a monitoring device needs to be installed, or additional agent software needs to be introduced into each device, which leads to a problem that a new investment in the equipment needs to be made.

### SUMMARY

The present invention has been made in view of the above-described problem, and an object of the present invention is, in a network system in which a plurality of users use a system within an organization through a shared terminal, to enable identification of communication source information, such as a user name, and specification of communication paths for respective pieces of the source information by referring to communication from the terminal, without introducing an additional device.

A network system according to the present invention is a network system that includes: a switch configured to receive a packet from a terminal, to identify source information of the packet, to append the source information to the packet based on an instruction, and to transmit the packet, to which the source information is appended, to a communication path based on the instruction; and a controller configured to issue the instruction to the switch.

A communication method according to the present invention is a communication method that includes: identifying source information of a packet based on the packet received from a terminal; appending the source information to the packet based on an instruction; and transmitting the packet, to which the source information is appended, to a communication path based on the instruction.

According to the present invention, in a network system in which a plurality of users use a system within an organization through a shared terminal, communication source information, such as a user name, can be identified and communication paths for respective pieces of the source information can be specified by referring to communications from the terminal, without introducing an additional device.

### BRIEF DESCRIPTION OF THE DRAWINGS

Exemplary features and advantages of the present invention will become apparent from the following detailed description when taken with the accompanying drawings in which:

FIG. 1 is a configuration diagram of a network system according to a first exemplary embodiment of the present invention;

FIG. 2 is a configuration diagram of a controller in the network system according to the first exemplary embodiment of the present invention;

FIG. 3 is a diagram illustrating a structure of a packet according to the first exemplary embodiment of the present invention;

FIG. 4 is a timing chart illustrating an operation of the network system according to the first exemplary embodiment of the present invention;

FIG. 5 is a flowchart illustrating an operation of the controller in the network system according to the first exemplary embodiment of the present invention;

FIG. 6 is a table illustrating a user information management table according to the first exemplary embodiment of the present invention;

FIG. 7 is a table illustrating a control rule management table according to the first exemplary embodiment of the present invention;

FIG. 8 is a table illustrating a path information management table for a case in which a user C establishes communication according to the first exemplary embodiment of the present invention;

FIG. 9 is a table illustrating a path information management table for a case in which a user A establishes communication according to the first exemplary embodiment of the present invention;

FIG. 10 is a table illustrating a session history management table according to the first exemplary embodiment of the present invention;

FIG. 11 is a table illustrating a user information management table for identifying an application according to a second exemplary embodiment of the present invention;

FIG. 12 is a table for converting application information according to the second exemplary embodiment of the present invention;

FIG. 13 is a table illustrating a control rule management table for identifying an application according to the second exemplary embodiment of the present invention;

FIG. 14 is a table illustrating a path information management table that enables an application ID to be embedded according to the second exemplary embodiment of the present invention; and

FIG. 15 is a table illustrating a session history management table for identifying an application according to the second exemplary embodiment of the present invention.

### EXEMPLARY EMBODIMENT

Hereinafter, exemplary embodiments of the present invention will be described with reference to the drawings. It is noted that although the exemplary embodiments described hereinafter set forth limitations that are technically preferable in order to implement the present invention, the scope of the invention is not limited to those described hereinafter.

### First Exemplary Embodiment

### Description of Configuration

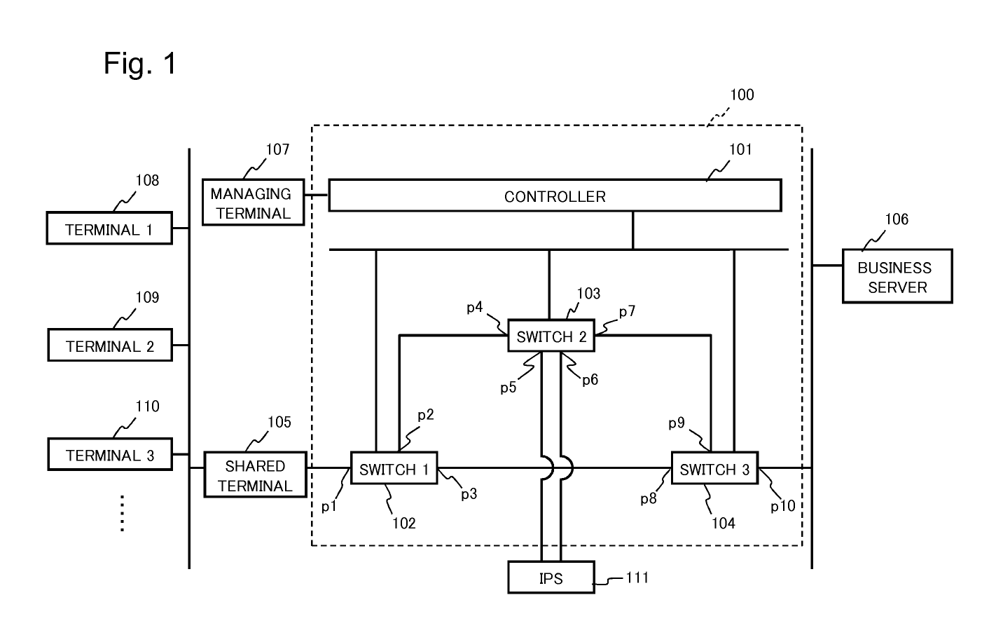

FIG. 1 is a configuration diagram of a network system according to a first exemplary embodiment of the present invention. A network system 100 according to the present exemplary embodiment includes a controller 101 and switches (switch 1 (102), switch 2 (103), and switch 3 (104)).

The switches (switch 1 (102), switch 2 (103), and switch 3 (104)) are devices that connect to a shared terminal 105, a business server 106, and the like, and can control contents and a path of a packet traveling through a network in response to an instruction from the controller 101. Although the description will be given using the multi-switch configuration illustrated in FIG. 1 in the present exemplary embodiment, the configuration of the switches is not limited to the one illustrated in FIG. 1.

The switches determine whether or not the packet is a packet that is registered in a flow table that is based on a path information management table, which will be described later, provided in the switches. When the packet is a registered packet, the switches append a user name identified in the flow table to the packet and transmit the packet to a path specified by the flow table. When the packet is a packet that is not registered in the flow table, the switches inquire of the controller 101 a path for the packet.

The path information management table is transmitted from the controller 101 to the switches. Upon receiving the path information management table, the switches update the flow table provided in the switches based on the path information management table. In the present exemplary embodiment, the flow table provided in each of the switches is compliant with the OpenFlow specification.

The switch 1 (102) is connected to the shared terminal 105. The switch 2 (103) is connected to an intrusion prevention system (IPS) (111). The switch 3 (104) is connected to the business server 106 that provides a service for a user.

The switch 1, the switch 2, and the switch 3 may be constituted by switches that can control contents and a path of a packet traveling through the network in response to an instruction from the controller 101 and that are compliant with Software Defined Networking (SDN) and, in particular, compliant with OpenFlow. In FIG. 1, p1 through p10 are denotations indicating IDs that allow network ports of the respective switches to be uniquely identified.

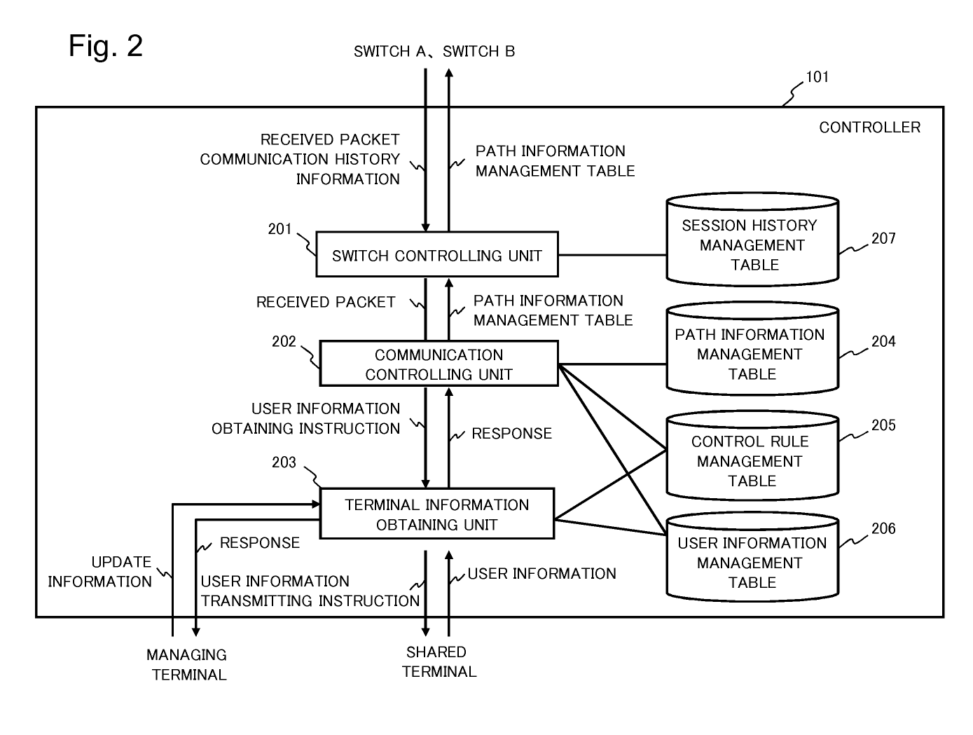

The controller 101 can create a path information management table that specifies a path for the packet and can transmit the created path information management table to the switches. FIG. 2 illustrates a configuration of the controller 101.

The controller 101 includes a switch controlling unit 201, a communication controlling unit 202, and a terminal information obtaining unit 203. The controller 101 further includes a path information management table 204, a control rule management table 205, a user information management table 206, and a session history management table 207. The path information management table 204 specifies a path for a packet at the respective switches for each user. The control rule management table 205 defines a rule for controlling a path for the packet for each user. The user information management table 206 retains information for identifying a user who is in communication. The session history management table 207 stores a communication history of the packet.

The switch controlling unit 201 is provided with a function of obtaining a communication history periodically or at any timing from the switches (switch 1 (102), switch 2 (103), and switch 3 (104)) and updating the session history management table 207. The switch controlling unit 201 is further provided with a function of receiving a packet transferred from the respective switches and relaying the packet to the communication controlling unit 202, and a function of receiving the path information management table 204 created by the communication controlling unit 202 and transmitting the received path information management table 204 to the respective switches.

The communication controlling unit 202 is provided with a function of comparing contents of a packet transferred from the switch controlling unit 201 with the user information management table 206 and the control rule management table 205 to determine a communication path for a user of the packet and to create the path information management table 204. The created path information management table 204 is transmitted to the switch controlling unit 201. The communication controlling unit 202 is further provided with a function of instructing the terminal information obtaining unit 203 to obtain, from the shared terminal 105, user information and the like of a user who is logged in to the shared terminal 105.

The terminal information obtaining unit 203 is provided with a function of obtaining, from the shared terminal 105, user information, such as information for identifying a user who is logged in to the shared terminal 105, periodically or in response to an instruction from the communication controlling unit 202, and updating the user information management table 206. The terminal information obtaining unit 203 is further provided with a function of obtaining information for updating the user information management table 206 and the control rule management table 205 from an external managing terminal 107, and updating the user information management table 206 and the control rule management table 205.

The shared terminal 105 is a device on a network that accepts logins from a plurality of users simultaneously and allows the users to use shared machine resources.

The business server 106 is a device on the network that can provide a service in response to a request from the shared terminal 105.

The managing terminal 107 is a device connected to the controller 101 and provided with a function of managing the controller 101.

A terminal 1 (108), a terminal 2 (109), and a terminal 3 (110) are terminals of respective users who use a service provided by the business server 106. For example, a user C can log in to the shared terminal 105 from the terminal 1 and receive a web service that operates on the business server 106.

The IPS (111) is a device provided with an intrusion detection and protection function that enables a control in which the IPS (111) refers to a header section or a payload section of a traveling packet, discards a communication based on a preset rule, and the like.

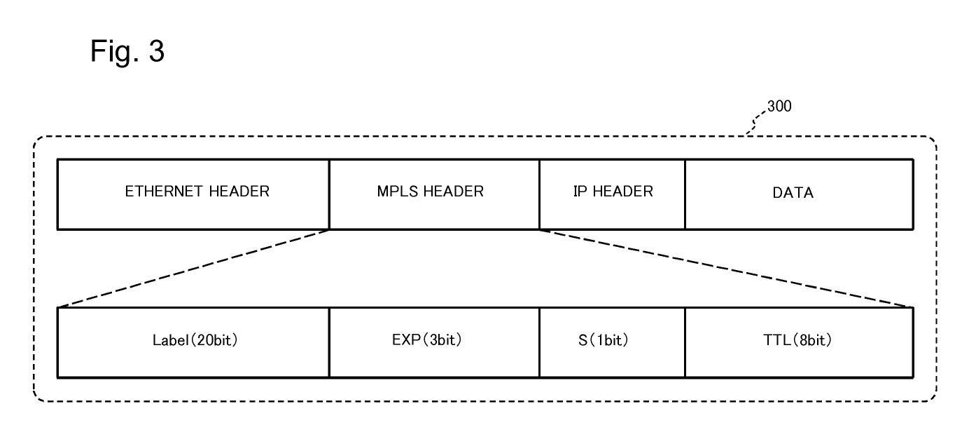

FIG. 3 illustrates a structure of a packet traveling through a network. A packet 300 includes an Ethernet (registered trademark) header, an MPLS header, an IP header, and data. The Ethernet header includes a MAC address and a protocol number. The IP header includes an IP address. The data includes a port number and the like in the case of Transmission Control Protocol (TCP) or UDP communication.

The MPLS header includes a label field (Label), an Experimental Use field (EXP), an S (Bottom of Label Stack) field (S), and a Time to Live field (TTL). The MPLS header is appended after the packet 300 passes through a switch.

The label field is a field to which an MPLS label is mapped. In the present exemplary embodiment, information, such as a user ID, for identifying a user can be stored into 20 bits of the label field in the MPLS header.

The Experimental Use field is a field for carrying Class of Service (CoS) information. The S field indicates a final label among stacked labels, in which 0 indicates that there is a label to follow and 1 indicates that there is no label to follow. The TTL field stores a TTL value. It is noted that the structure of the packet according to the present exemplary embodiment is not limited to the structure illustrated in FIG. 3.

(Description of Operation)

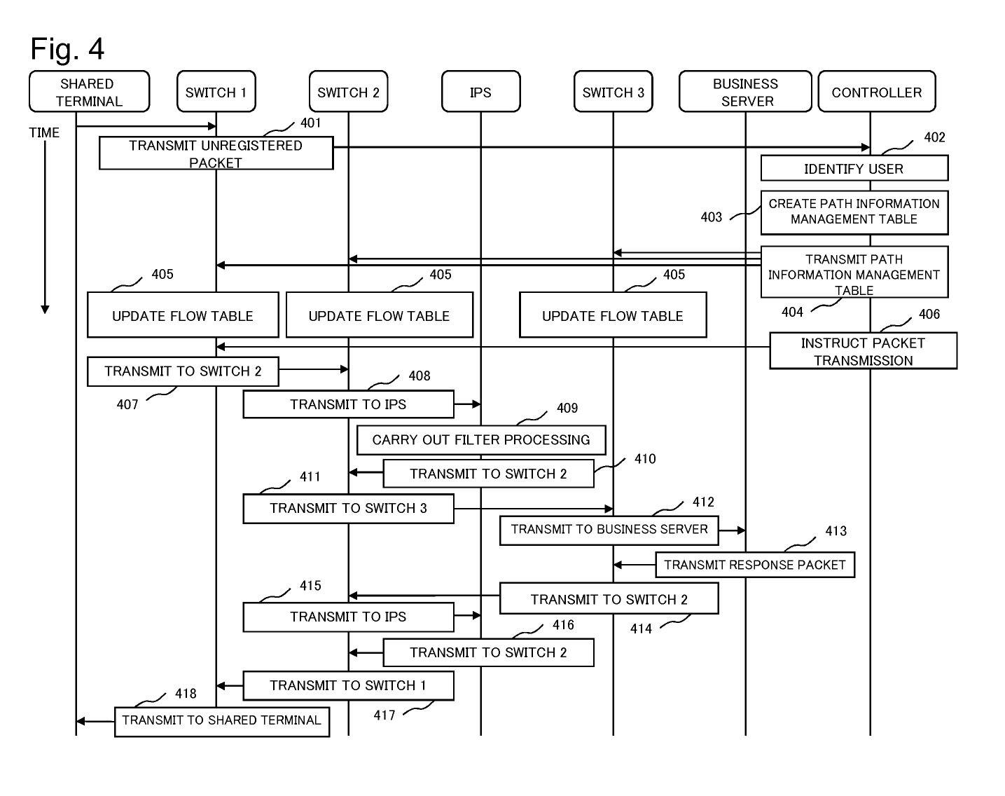

FIG. 4 is a timing chart illustrating an operation of the network system according to the present exemplary embodiment illustrated in FIG. 1. The operation will be described with reference to the timing chart illustrated in FIG. 4.

A case in which a user C logs in to the shared terminal 105 having an IP address of 10.1.1.1 from the terminal 1 (108) and makes a request (communication with a destination port number tcp/443) for a web service that operates on the business server 106 having an IP address of 10.1.1.200 will be described as an example.

Upon receiving a request packet from the shared terminal 105, the switch 1 searches through a flow table provided in the switch 1, with information (an ingress port, a source MAC address, a destination MAC address, a protocol number, a source IP address, a source port number, a destination IP address, a destination port number, and the like) included in the request packet serving as a key, and determines whether or not a flow table for the user of the request packet is present.

At this point, the packet does not include information, such as a user ID, for identifying the user. However, a flow table provided in each switch has a short life time in each switch (corresponding to Idle Timeout, which will be described later), and when there is a flow table having information that matches the aforementioned pieces of information of the packet within this life time, the packet can be determined to be a packet of the user of the flow table. In other words, the user can be identified.

It is noted that, as will be described later, when a packet enters the network system 100 from the outside of the network system 100, the packet may not include information for identifying a user. In a case that a packet does not include information for identifying a user, not only the switch 1 but each of the switches can also identify a user through the method described above. In order to identify a user through the above-described method, however, a plurality of items need to be compared.

In a case that a flow table corresponding to the packet is not present in the switch 1, the switch 1 once stores the packet into a reception buffer included in the switch 1. The switch 1 then transmits, to the controller 101, the packet as an unregistered communication and requests, from the controller 101, an instruction as to a communication path for the packet and for a subsequent packet (step 401).

Meanwhile, in a case that a corresponding flow table is present in the switch 1, the switch 1 appends information for identifying a user to the packet and transmits the packet to a communication path designated by the flow table. Here, the switch 1 transmits the packet to the switch 2. This process corresponds to step 407, which will be described later.

Upon receiving the packet, the controller 101 searches the user information management table 206 that includes information, which is obtained from the shared terminal 105, for identifying a user of the packet, with header information of the packet (a source IP address, a source port number, a destination IP address, a destination port number, and a protocol number) serving as a key (step 402).

When the controller 101 confirms that the packet is a packet of a user registered in the user information management table 206, the controller 101 creates the path information management table 204 for the packet. At this point, the controller 101 creates the path information management table 204 of the packet based on the control rule management table 205 that defines a rule for controlling a path of the packet of the user (step 403).

The control rule management table 205 can be updated through an input from the managing terminal 107.

The controller 101 creates path information management tables 204 for the respective switches and transmits the corresponding path information management table 204 to each of the switch 1, the switch 2, and the switch 3 (step 404).

Upon receiving the respective path information management tables 204, the switch 1, the switch 2, and the switch 3 update the flow tables provided in the respective switches based on the path information management tables 204 (step 405).

After the controller 101 transmits the path information management tables 204 to the switch 1, the switch 2, and the switch 3, the controller 101 instructs the switch 1 to transmit the packet stored in the reception buffer of the switch 1 (step 406).

In response to the instruction in step 406, the switch 1 transmits the packet through the p2 port of the switch 1 based on the flow table provided in the switch 1. At this time, the switch 1 transmits the packet after appending information for identifying a user to the header section of the packet (step 407).

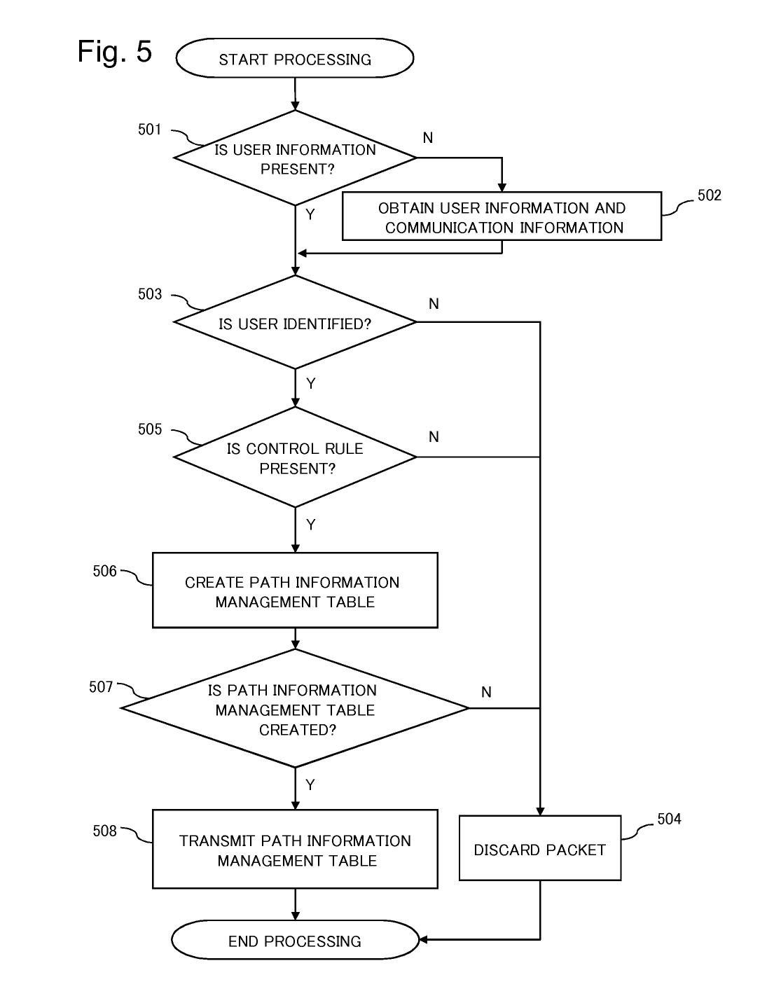

Subsequently, an operation flow in steps 402 through 404 is reorganized in terms of an operation of the controller 101, which results in FIG. 5. FIG. 5 is a flowchart illustrating the operation of the controller 101. The operation of the controller 101 according to the present exemplary embodiment will be described with reference to FIG. 5.

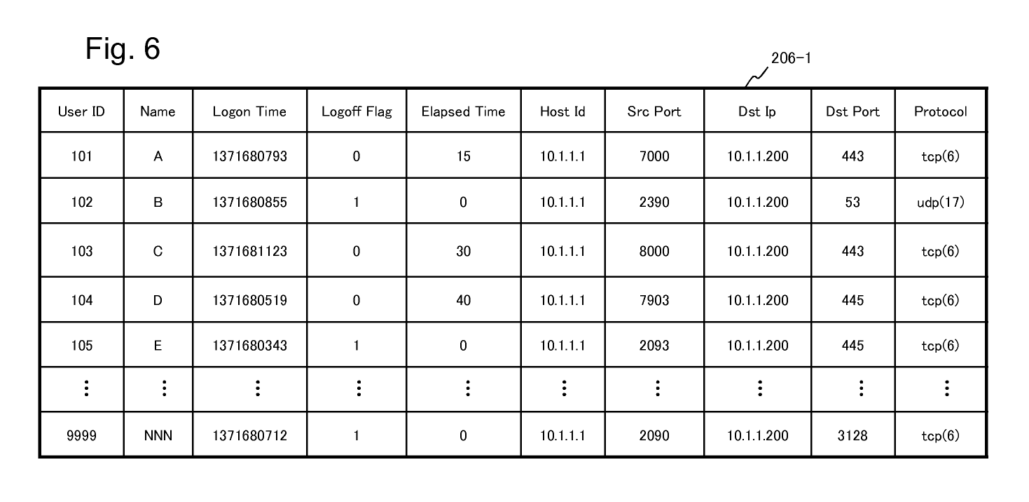

Upon receiving an unregistered packet from the switch 1, in step 501, the controller 101 refers to a user information management table 206-1 illustrated in FIG. 6 and determines whether or not user information which the controller 101 receives periodically from the shared terminal 105 is present in the user information management table 206-1.

FIG. 6 illustrates the user information management table 206-1. The columns labeled User ID, Name, Logon Time, Logoff Flag, Elapsed Time, Host Id, Src Port, Dst Ip, Dst Port, and Protocol in the user information management table 206-1 illustrated in FIG. 6 indicate, respectively, an identifier that allows a user to be identified uniquely, a user name, a logon time, a flag indicating that a user logs off, an elapsed time after information is obtained, an identifier that allows a host to which a user logs on to be identified uniquely, a source port number, a destination IP address, a destination port number, and a protocol number.

Specifically, the controller 101 determines whether or not there is a row containing 0 under the column labeled Logoff Flag, or in other words, a user is logged in, and containing a source IP address of the packet, or in other words, an IP address of the shared terminal 105, under the column labeled Host Id. At this time, the controller 101 ignores a row containing, for example, a value of 60 seconds or more under the column labeled Elapsed Time so that the controller 101 can refer to more accurate information. Elapsed Time indicates an elapsed time after the controller 101 obtains the user information from the shared terminal 105. When the user information is present (Y), the processing proceeds to step 503. When the user information is not present (N), the processing proceeds to step 502. It is noted that when a row containing Elapsed Time of 60 seconds or more is present, the controller 101 may make a determination of N.

In step 502, the controller 101 obtains, from the shared terminal 105, user information of a user who is logged in to the shared terminal 105 and information on a communication performed by the user who is logged in. Specifically, the controller 101 obtains a set containing the user ID, the source IP address, the source port number, the destination IP address, the destination port number, and the protocol number, and updates the user information management table 206-1 with the obtained information. FIG. 6 illustrates the user information management table 206-1 after the update.

The controller 101 can obtain information from the shared terminal 105 without introducing software, such as an agent, into the shared terminal 105. For example, the controller 101 can obtain information through a method in which Remote Registry or MS-RPC is used, or through a method in which a command is executed remotely by using SSH public key authentication. After the controller 101 obtains the information, the processing proceeds to step 503.

In step 503, the controller 101 searches the user information management table 206-1 based on the information of the packet received from the switch 1. Specifically, the controller 101 extracts, from the user information management table 206-1, a row in which a value under the column labeled Logoff Flag is 0, or in other words, the user is logged in, and in which contents under the columns labeled Host Id, Src Port, Dst Ip, Dst Port, and Protocol matches the information (the source IP address, the source port number, the destination IP address, the destination port number, and the protocol number) of the packet. When a corresponding row is present (Y), the processing proceeds to step 505. When a corresponding row is not present (N), the processing proceeds to step 504.

In step 504, the controller 101 instructs the switch 1 to discard the packet and a subsequent packet stored in the reception buffer of the switch 1, and the processing is then terminated.

In step 505, the controller 101 refers to a row, one by one, that is extracted in step 503 and searches the control rule management table 205 to determine whether or not there is a row that matches the extracted row.

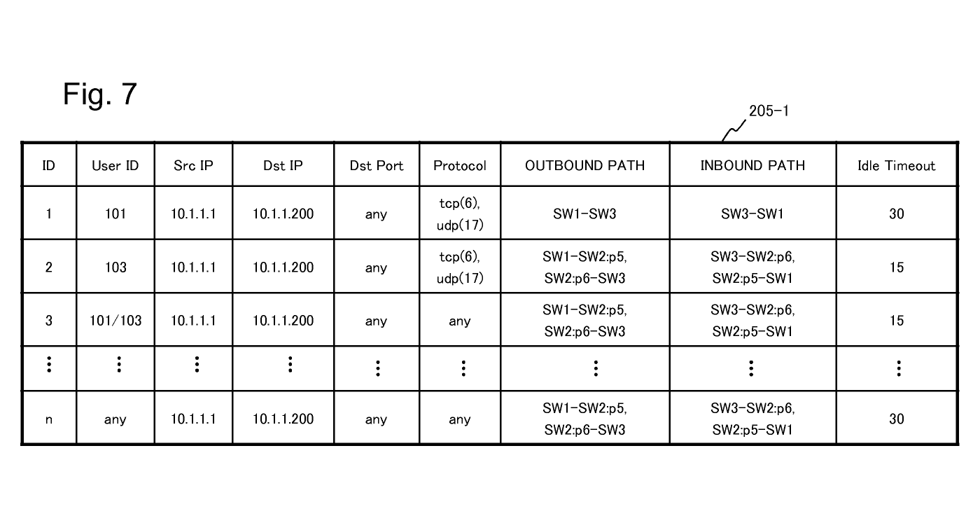

FIG. 7 illustrates a control rule management table 205-1. The columns labeled ID, User ID, Src IP, Src Port, Dst IP, Dst Port, Protocol, Outbound Path, Inbound Path, and Idle Timeout in the control rule management table 205-1 illustrated in FIG. 7 indicate, respectively, an identifier that allows a rule to be identified uniquely, an identifier that allows a user to be identified uniquely, a source IP address, a source port number, a destination IP address, a destination port number, a protocol number, information that allows an outbound path of the communication to be identified, information that allows an inbound path of the communication to be identified, and a time in which the path information management table 204 is deleted after becoming a non-communication state.

Specifically, the controller 101 compares contents under the columns labeled User Id, Host Id, Src Port, Dst Ip, Dst Port, and Protocol in the user information management table 206-1 with contents under the columns labeled User Id, Src IP, Dst IP, Dst Port, and Protocol in the control rule management table 205-1 to determine whether or not there is a row containing contents that match. When a matching row is present (Y), the processing proceeds to step 506. When a matching row is not present (N), the processing proceeds to step 504.

In step 506, the controller 101 refers to information in the user information management table 206-1 extracted in step 505 and creates the path information management table 204. The controller 101 creates the path information management table 204 so that an MPLS header is appended to the packet and the user ID is stored in the MPLS header during a period from when the packet goes under the OpenFlow control to when the packet goes out of the OpenFlow control. In other words, according to the present exemplary embodiment, when a packet is within the network system 100, a user ID is appended to the packet, and the user ID is removed when the packet goes outside the network system 100.

The MPLS header is removed at a timing when the packet goes out of the OpenFlow control because the shared terminal 105, the business server 106, and the IPS 111 that are not under the OpenFlow control cannot interpret the MPLS header even when receiving a packet that includes the MPLS header, and discard the packet.

Prior to specifically describing a method for creating the path information management table 204, contents under the columns labeled Outbound Path and Inbound Path in the control rule management table 205-1 will be described with reference to FIG. 7. Data under the columns labeled Outbound Path and Inbound Path in the control rule management table 205-1 are in the following format, and a plurality of paths can be specified by separating the paths by a comma.

ingress switch:ingress port-egress switch:egress port

An identifier of a switch that serves as an ingress to the OpenFlow network and an identifier that indicates a network port through which a packet enters the network are specified, respectively, in the ingress switch and the ingress port. In a case that the ingress port can be identified uniquely from information under Src IP in the control rule management table 205-1, specification of the ingress port can be omitted.

An identifier of a switch that serves as an egress from the OpenFlow network and an identifier that indicates a network port through which a packet goes outside the network are specified, respectively, in the egress switch and the egress port. In a case that the egress port can be identified uniquely from information under Dst IP in the control rule management table 205-1, specification of the egress port can be omitted.

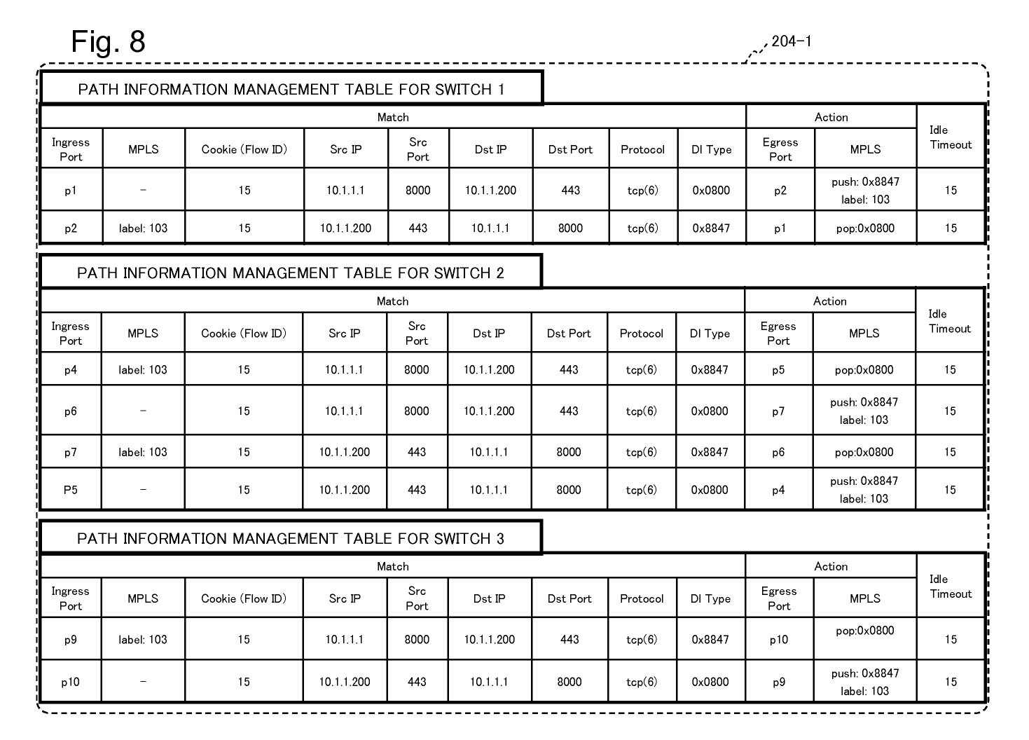

The path information management table 204 is created by sequentially following comma-separated pieces of data indicated under the columns labeled Outbound Path and Inbound Path and also by referring to the other parameters in the given row of the control rule management table 205-1. Hereinafter, with reference to FIGS. 7 and 8, a specific method for creating the path information management table 204 will be described with a case of switch 1-switch 2:p5 indicated under the column labeled Outbound Path in the given row as an example.

FIG. 8 illustrates path information management tables 204-1 to be created herein. The path information management tables 204-1 are created for the respective switches. The columns labeled Ingress Port, MPLS, Cookie, Src IP, Src Port, Dst IP, Dst Port, Protocol, and DI Type under Match column, the columns labeled Egress Port and MPLS under Action column, and Idle Timeout column in the path information management table 204-1 indicate, respectively, an ingress port, a condition on comparing MPLS headers, an identifier that allows a flow to be identified uniquely (to be used for deleting flows at once or updating flows at once), a source IP address, a source port number, a destination IP address, a destination port number, a protocol number, an Ethernet type number, an egress port, an MPLS action, and a time in which the path information management table 204 is deleted after becoming a non-communication state.

In FIG. 7, the user C corresponds to a case that ID in the given control rule management table 205-1 is 2, and thus a communication path is determined by referring to the columns labeled Outbound Path and Inbound Path across the row in which ID is 2. Specifically, comma-separated pieces of information under the columns labeled Outbound Path and Inbound Path in the control rule management table 205-1 are sequentially referred, and then information in the path information management table 204-1 is created.

A path information management table is created for each of the switch 1 and the switch 2 from the information of SW1-SW2:p5. Hereinafter, SW1 corresponds to the switch 1; SW2 corresponds to the switch 2; and SW3 corresponds to the switch 3.

First, values to be registered under the columns labeled Ingress Port and Egress Port of the path information management table 204-1 are determined. Information on the ingress port of the switch 1 is omitted, and thus it is determined that an identifier for the ingress port is p1 from information of Src IP in the control rule management table 205-1. The egress port of the switch 1 is a port connected to the switch 2, and thus the egress port is identified as p2. In a similar manner, the ingress port of the switch 2 is identified as p4, and the egress port thereof is identified as p5.

Subsequently, values under the Action column are determined. Processing of appending an MPLS header at a timing when a packet goes under the OpenFlow control and removing the MPLS header at a timing when the packet goes out of the OpenFlow control is registered.

An action of appending the MPLS header is registered for the switch 1, and an action of removing the MPLS header is registered for the switch 2. When appending the MPLS header, contents in the control rule management table 205-1 are referred, and 103, which is the identifier for the user C, is inserted into the label field of the MPLS header. A condition indicating that the identifier (103) for the user C is appended to the MPLS label is registered under the column labeled MPLS under the Match column for the switch 2.

Thereafter, values under the columns (User ID, Src IP, Dst IP, Dst Port, Protocol, Outbound Path, Inbound Path, and Idle Timeout) in the control rule management table 205-1 are referred, and then the remaining columns in the path information management table 204-1 are created. An ID that allows a series of paths to be identified uniquely is registered under the column labeled Cookie. The column labeled Cookie is used to update or delete the path information management table 204-1 at once. Under the column labeled DI Type, 0x0800 indicating that the packet is an IPv4 packet or 0x8847 indicating that the packet is MPLS unicast is registered in accordance with contents of a packet entering through a port indicated under the column labeled Ingress Port.

Thus far, the path information management tables 204-1 to be registered into the flow tables for the switch 1 and the switch 2 are respectively created based on the information of SW1-SW2:p5. In a similar manner, comma-separated pieces of data indicated under the columns labeled Outbound Path and Inbound Path are sequentially processed so as to create the path information management table 204-1. FIG. 8 illustrates the path information management table 204-1 created by processing the entire pieces of information on the outbound path and the inbound path.

In step 507, the controller 101 determines whether or not the path information management tables 204-1 to be registered in the respective switches are created. When the path information management tables 204-1 are not created (N), the processing proceeds to step 504. When the path information management tables 204-1 are created (Y), the processing proceeds to step 508.

In step 508, the controller 101 transmits the path information management tables 204-1 created for the switch 1, the switch 2, and the switch 3 in step 506 to the switch 1, the switch 2, and the switch 3 respectively, and the processing is then terminated. In other words, the path information management table transmitted from the controller 101 to, for example, the switch 1, is a table corresponding to the switch 1. Each of the switches receives a table that corresponds to the switch, among the path information management tables created by the controller 101, and updates the flow table thereof. The path information management tables 204-1 serve as instructions for the switch 1, the switch 2, and the switch 3 to specify a communication path for the packet.

Thus far, the operation of the controller 101 has been described.

When a time under Idle Timeout in the path information management table 204-1 elapses, the corresponding path information management table 204-1 is deleted. Therefore, the controller 101 recreates a path information management table 204 through the steps illustrated in FIG. 5 based on a request from a switch.

After the operation illustrated in FIG. 5, the controller 101 instructs the switch 1 to transmit a request packet (step 406).

In response to the instruction in step 406, the switch 1 transmits a request packet through the p2 port of the switch 1 based on the flow table provided in the switch 1. At this time, the switch 1 appends a label of the MPLS header to the request packet, stores a user ID into the label of the MPLS header, and transmits the request packet (step 407). As the user ID is appended here, each switch can identify the user of the request packet by referring to the header of the request packet and can specify a communication path for each user.

The switch 2 checks the user ID in the label of the MPLS header of the request packet, and transmits the packet to the IPS 111 through the p5 port as indicated under the column labeled Egress Port based on the flow table provided in the switch 2. At this time, the switch 2 transmits the packet after removing the label of the MPLS header in which the user ID is stored, in accordance with the column labeled MPLS under the Action column of the path information management table 204-1 (step 408).

The IPS 111 compares the header section of the received request packet with a preset filter setting and determines whether or not the communication can be transferred (step 409). Hereinafter, the description proceeds in a case that the transfer is allowed in the IPS 111. The IPS 111 refers to the header section of the request packet and a routing table thereof, and transmits the packet to the switch 2 (step 410).

The switch 2 searches the flow table provided in the switch 2 with information (an ingress port, a source MAC address, a destination MAC address, a protocol number, a source IP address, a source port number, a destination IP address, a destination port number, and the like) included in the request packet serving as a key, and identifies a user of the packet. Thereafter, the switch 2 transmits the packet to the switch 3 through the p7 port as indicated under the column labeled Egress Port based on the flow table. At this time, the switch 2 appends a label of the MPLS header to the packet, stores the user ID into the label of the MPLS header, and transmits the packet (step 411).

The switch 3 checks the user ID in the label of the MPLS header of the request packet, and transmits the packet to the business server 106 through the p10 port as indicated under the column labeled Egress Port based on the flow table provided in the switch 3. At this time, the switch 3 transmits the packet after removing the label of the MPLS header in which the user ID is stored, in accordance with the path information management table 204-1 (step 412).

The business server 106 responds to a request from the client and transmits a response packet to the switch 3 (step 413).

The switch 3 searches the flow table with information (an ingress port, a source MAC address, a destination MAC address, a protocol number, a source IP address, a source port number, a destination IP address, a destination port number, and the like) included in the response packet serving as a key, and identifies a user of the packet. Thereafter, the switch 3 transmits the packet to the switch 2 through the p9 port as indicated under the column labeled Egress Port based on the flow table. At this time, the switch 3 appends a label of the MPLS header to the packet, stores the user ID into the label of the MPLS header, and transmits the packet (step 414).

The switch 2 checks the user ID in the label of the MPLS header of the response packet, and transmits the packet to the IPS 111 through the p6 port as indicated under the column labeled Egress Port based on the flow table. At this time, the switch 2 transmits the packet after removing the label of the MPLS header in which the user ID is stored, in accordance with the flow table (step 415).

The IPS 111 refers to the header section of the response packet and a routing table thereof and transmits the packet to the switch 2 (step 416).

The switch 2 searches the flow table with information included in the response packet serving as a key, and identifies a user of the packet. Thereafter, the switch 2 transmits the packet to the switch 1 through the p4 port as indicated under the column labeled Egress Port based on the flow table. At this time, the switch 2 appends a label of the MPLS header to the packet, stores the user ID into the label of the MPLS header, and transmits the packet (step 417).

The switch 1 checks the user ID in the label of the MPLS header of the response packet, and transmits the packet to the shared terminal 105 through the p1 port as indicated under the column labeled Egress Port based on the flow table. At this time, the switch 1 transmits the packet after removing the label of the MPLS header in which the user ID is stored, in accordance with the flow table (step 418).

A subsequent packet is delivered in accordance with the flow table that is based on the path information management table 204-1 set in step 405. Until the flow tables in the switch 1, the switch 2, and the switch 3 are deleted, processes similar to steps 407 through 418 are carried out.

When 15 seconds, which are time indicated under Idle Timeout in the path information management table 204-1, elapse, the corresponding flow table is deleted. After the flow table is deleted, the controller 101 creates a path information management table 204 through the steps illustrated in FIG. 5 based on a request from a switch.

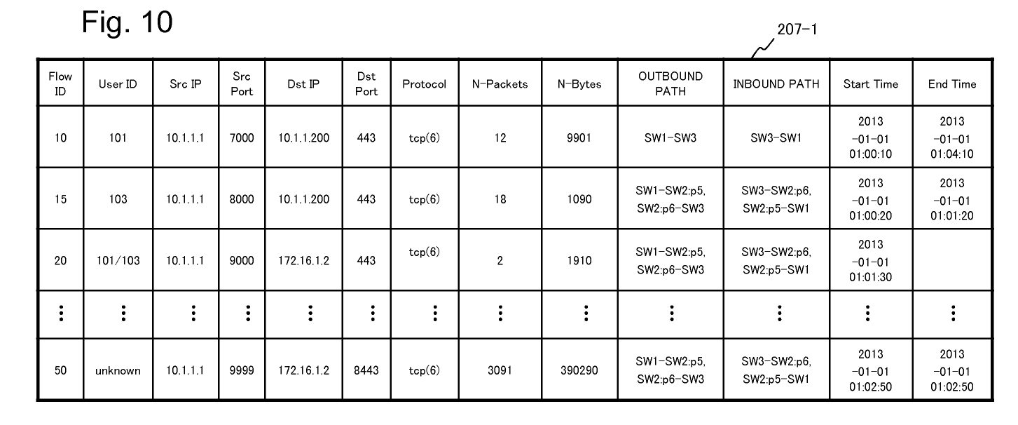

Each of the switches transmits a communication history to the controller 101 at a timing when the flow tables in the switch 1, the switch 2, and the switch 3 are deleted, or in other words, at a timing when the time under Idle Timeout in the path information management table 204-1 elapses. The controller 101 updates a session history management table 207-1 illustrated in FIG. 10 based on the communication history. The timing when each switch transmits the communication history to the controller 101 is not limited to the timing when the path information management table 204-1 is deleted, but may, for example, be a timing determined in response to an instruction transmitted from the controller 101.

FIG. 10 illustrates the session history management table 207-1. The columns labeled Flow ID, User ID, Src IP, Src Port, Dst IP, Dst Port, Protocol, n-packets, n-bytes, Outbound Path, Inbound Path, Start Time, and End Time in the session history management table 207-1 indicate, respectively, an identifier that allows a session to be identified uniquely, an identifier that allows a user who establishes the communication to be identified uniquely, a source IP address, a source port number, a destination IP address, a destination port number, a protocol number, the number of exchanged packets, the amount of exchanged packets, information that allows an outbound path of the communication to be identified, information that allows an inbound path of the communication to be identified, a time at which the session starts, and a time at which the session ends.

As the communication history is recorded in the session history management table 207-1, even after the communication is terminated, by comparing an access log of the business server 106 with contents in the session history management table 207-1, for example, a user who establishes the communication can be identified and the communication history information can be obtained.

Although the present exemplary embodiment has been described with a case that the user C establishes the communication as an example, similar processing can be carried out even in a case that a user A logs in to the shared terminal 105 having an IP address of 10.1.1.1 from the terminal 1 (108) and makes a request (communication with a destination port number tcp/443) for a web service that operates on the business server 106 having an IP address of 10.1.1.200.

A case that the user C is a general user and a packet is transmitted to the business server 106 through the IPS 111 serving as a firewall has been illustrated. In the meantime, the user A is a specific user as indicated in the control rule management table 205-1 illustrated in FIG. 7, and a packet is transmitted directly to the business server 106 without passing through the firewall. By differentiating a communication path for each user, the security level in the SDN can be differentiated.

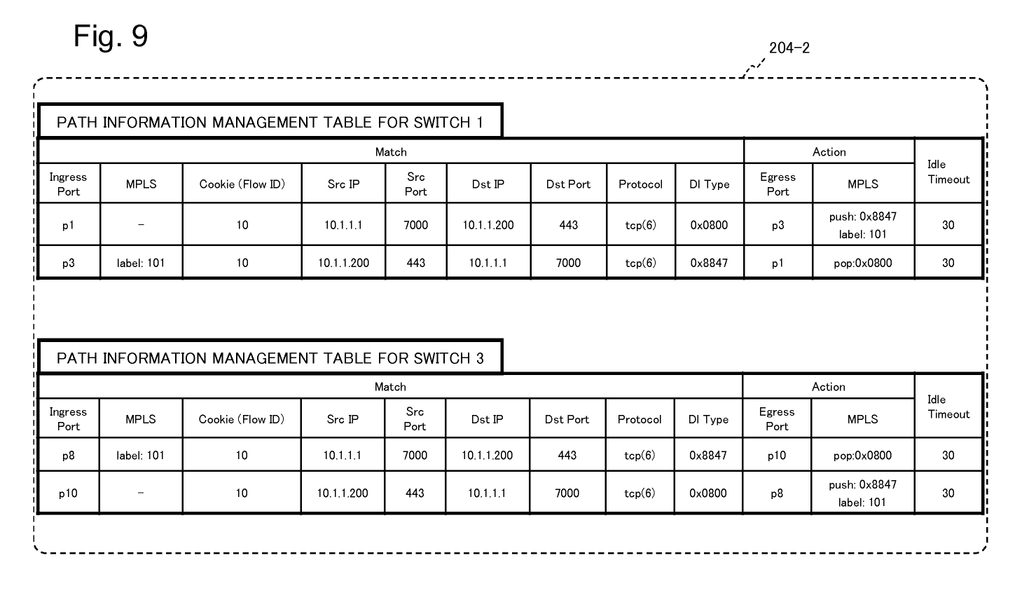

FIG. 9 illustrates a path information management table 204-2 for processing the communication established by the user A. A packet sent out by the user A is transmitted directly from the switch 1 to the switch 3 and does not pass through the switch 2 communicating through the firewall, both in the outbound path and in the inbound path. By updating the path information management table 204 based on the control rule management table 205, a communication path can be changed for each user.

According to the present exemplary embodiment, an IP datagram can be encapsulated by using an MPLS header, and thus even when the communication is encrypted by IPsec or the like, the process is not affected by the encryption. Even when the communication is encrypted, a user at the source can be identified based on header information of the packet. In other words, the present exemplary embodiment can be effectively applied to encrypted communication as well.

In the case of MPLS, typically, a switch replaces a label each time a packet passes through the switch. However, when the switch replaces the label, an association between the communication and the user cannot be made instantaneously on a communication path. Therefore, in the present exemplary embodiment, the description has been made on a method in which a typical replacement of the label is not carried out by the switch. Meanwhile, while the label and the user need to be associated with each other, the label may be replaced by the switch in accordance with the MPLS specification.

Although the label of the MPLS header has been used as a location into which user information is embedded in the present exemplary embodiment, by securing an area into which user information is embedded, a location other than the label of the MPLS header can be used. For example, there is a method in which a flow label of an IPv6 header or a TOS field of an IPv4 header is used.

In a case that an IPv6 header or an IPv4 header is used, user information does not need to be removed even when a packet goes out of the OpenFlow control. In other words, the user information that is once appended to the packet is retained thereafter, and each switch can identify a user based on the appended user information. In addition, each switch does not need to append duplicate user information to a packet to which user information is appended.

The controller 101 and the switches (the switch 1 (102), the switch 2 (103), and the switch 3 (104)) that constitute the network system 100 according to the present exemplary embodiment are devices that constitute an OpenFlow-compliant network. Since the present exemplary embodiment is applied to an OpenFlow-compliant network, an additional device is not required to implement the present exemplary embodiment.

As described above, according to the present exemplary embodiment, in a network system in which a plurality of users use a system within an organization through a shared terminal, communication source information, such as a user name, can be identified and a communication path for each user name can be specified by referring to a communication from the terminal without introducing an additional device. In addition, a communication history can be traced for each user name.

### Second Exemplary Embodiment

As a second exemplary embodiment of the present invention, a method that allows an application used for communication to be identified uniquely not only from an association between the communication and a user but also from information on a packet traveling through a communication path will be described.

This can be implemented by extending part of each of the user information management table 206, the control rule management table 205, the path information management table 204, and the session history management table 207 in the controller 101 by using the configurations illustrated in FIGS. 1 and 2.

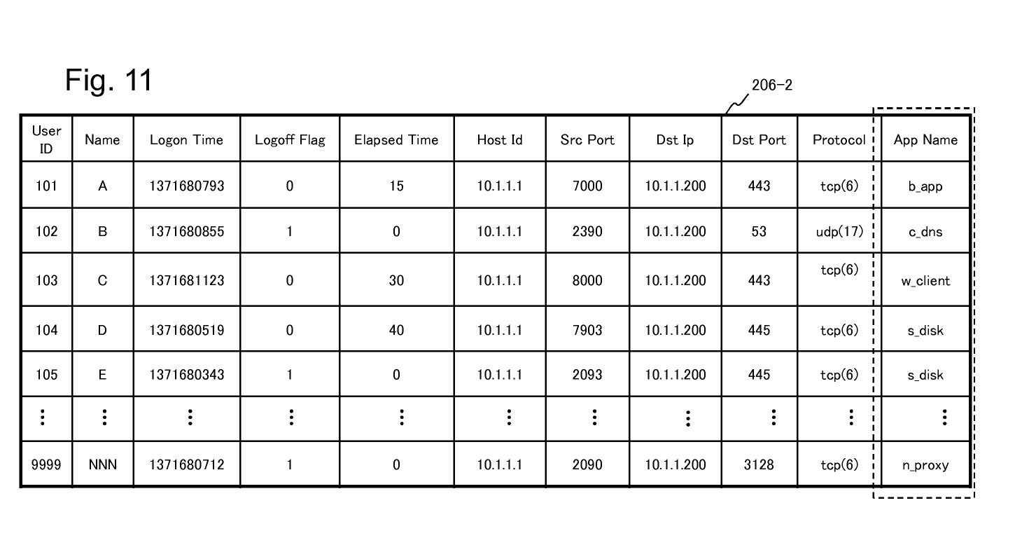

FIG. 11 illustrates a user information management table 206-2 that is extended. The column labeled App Name, which is enclosed by a dotted line, is extended. The terminal information obtaining unit 203 obtains a process name of an application from the shared terminal 105, and the process name is stored as a value under the column. The amount of information that can be embedded into a packet is limited, and the amount of information becomes large if the process name is entered as is, and thus the process name can be converted to an identifier that allows the application to be identified uniquely, prior to embedding the information into the packet.

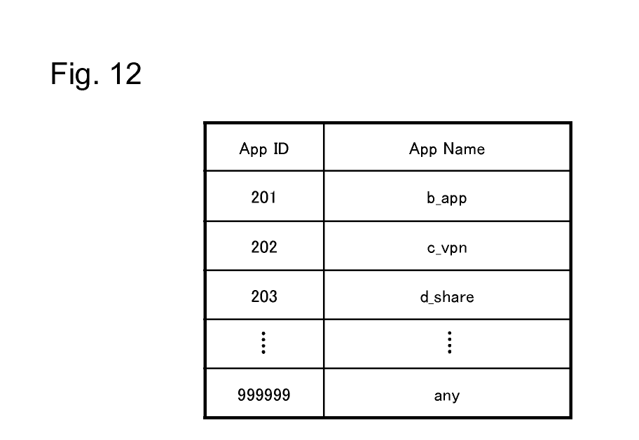

FIG. 12 illustrates a table that stores information for conversion. The communication controlling unit 202 of the controller 101 is extended, and the value under the column labeled App Name can be converted to an identifier App ID that allows the application to be identified uniquely by referring to the tables illustrated in FIGS. 11 and 12 when creating the path information management table 204.

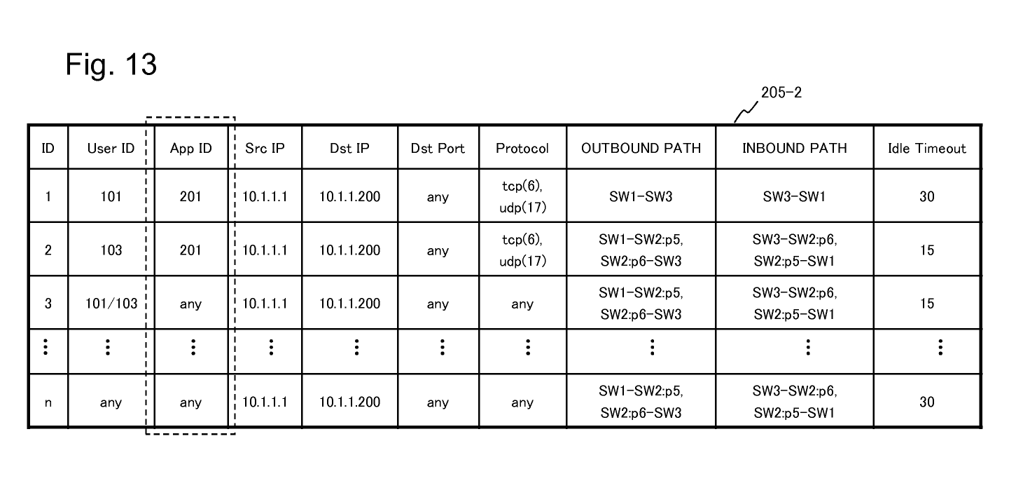

FIG. 13 illustrates a control rule management table 205-2 that is extended along with extension of the user information management table 206 in order to realize communication control for each application. A portion enclosed by a dotted line is the extended column. An identifier that allows the application to be identified is stored under the column labeled App ID, which makes it possible to control each application.

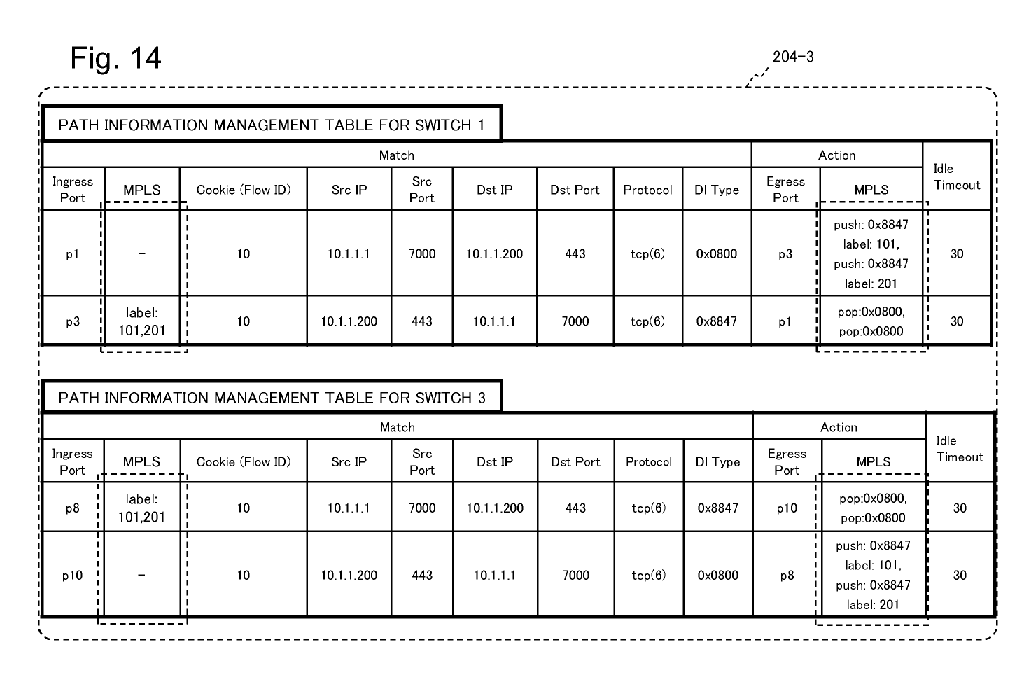

The processing of embedding information that allows the application to be identified uniquely into a packet is realized by extending the operation in step 506 described in the first exemplary embodiment. When creating the path information management table 204, an identifier that allows the application to be identified uniquely, which is added to the user information management table 206-2 and the control rule management table 205-2, is obtained and appended to the packet along with the user ID in the form of a label of the MPLS header, to realize the processing. FIG. 14 illustrates path information management tables 204-3 created for the respective switches. The path information management tables 204-3 illustrated in FIG. 14 are obtained by updating the path information management tables 204-2 illustrated in FIG. 9, and a portion enclosed by a dotted line in the table for each switch indicates cells that are updated by adding an identifier for the application.

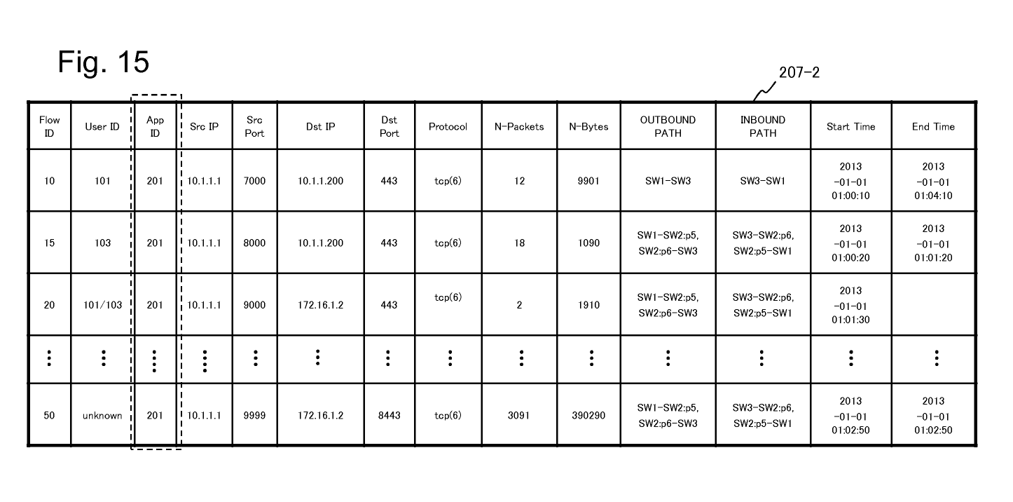

After the communication is completed, in order to allow not only the user ID but also information on the used application to be tracked down, the session history management table 207 is also extended in a similar manner to the control rule management table 205-2. FIG. 15 illustrates a session history management table 207-2 that is extended. A portion enclosed by a dotted line is the extended column. An identifier that allows the application to be identified is stored under the column labeled App ID, which makes it possible to track down the used application.

As the second exemplary embodiment of the present invention, a method for additionally embedding the identifier for the application into a packet has been described. When embedding the information into the packet, by utilizing a structure of the label of the MPLS header, as in the case of a user name and an application name, personal information, such as a nationality, an occupation, an age, and a place of birth, or individual information, such as an identifier for a file on classified information to which an application refers, can be embedded into a packet in a plurality of stages.

As in the case of the application name, the above can be achieved as the shared terminal 105 includes the aforementioned personal information or individual information and as the controller 101 obtains the aforementioned personal information or individual information from the shared terminal 105. At this time, the controller 101 has only to include a user information management table corresponding to FIG. 11, a table storing personal information and individual information for conversion corresponding to FIG. 12, and a control rule management table corresponding to FIG. 13, create a path information management table corresponding to FIG. 14, and save a session history management table corresponding to FIG. 15.

According to the present exemplary embodiment, by referring to the header section of the packet, the user name, the application name, the personal information, and the individual information, as communication source information, can be identified. Accordingly, the communication can be controlled by a combination of the aforementioned plurality of pieces of information, and thus the present exemplary embodiment can be utilized for the network security.

As described above, according to the present exemplary embodiment, in a network system in which a plurality of users use a system within an organization through a shared terminal, a user name, an application name, personal information, and individual information, as communication source information, can be identified, and a communication path can be specified for each piece of source information by referring to communication from the terminal, without introducing an additional device. In addition, a communication history can be traced for each piece of source information.

The present invention is not limited to the exemplary embodiments described above. Various modifications can be made within the scope of the invention set forth in the claims, and it is needless to say that such modifications are encompassed by the scope of the present invention.

In addition, part or all of the exemplary embodiments described above can also be described as in the following supplementary notes but is not limited thereto.

Supplementary Notes

(Supplementary Note 1)

A network system that includes a switch configured to receive a packet from a terminal, to identify source information of the packet, to append the source information to the packet based on an instruction, and to transmit the packet, to which the source information is appended, to a communication path based on the instruction; and a controller configured to issue the instruction to the switch.

(Supplementary Note 2)

The network system according to Supplementary Note 1, wherein the source information is information for identifying at least one of a user name and an application name.

(Supplementary Note 3)

The network system according to Supplementary Note 1 or 2, wherein the instruction includes an instruction for appending the source information to the packet and an instruction for specifying the communication path for respective pieces of the source information.

(Supplementary Note 4)

The network system according to any one of Supplementary Notes 1 through 3, wherein the switch identifies the source information based on information on the packet, and requests the instruction as to the packet to the controller in a case that the switch is unable to identify the source information.

(Supplementary Note 5)

The network system according to any one of Supplementary Notes 1 through 4, wherein the controller identifies the source information from information obtained from the terminal and information on the packet.

(Supplementary Note 6)

The network system according to any one of Supplementary Notes 1 through 5, wherein the controller issues the instruction based on a rule for controlling the communication path that is determined in advance for respective pieces of the source information.

(Supplementary Note 7)

The network system according to any one of Supplementary Notes 1 through 6, wherein the switch transmits a history of the communication path of the packet to the controller, and the controller saves the history.

(Supplementary Note 8)

The network system according to any one of Supplementary Notes 1 through 7, wherein the switch appends the source information to a header section of the packet.

(Supplementary Note 9)

A communication method that includes identifying source information of a packet based on the packet received from a terminal; appending the source information to the packet based on an instruction; and transmitting the packet, to which the source information is appended, to a communication path based on the instruction.

(Supplementary Note 10)

The communication method according to Supplementary Note 9, wherein the source information identifies at least one of a user name and an application name.

(Supplementary Note 11)

The communication method according to Supplementary Note 9 or 10, wherein the instruction includes an instruction for appending the source information to the packet and an instruction for specifying the communication path for respective pieces of the source information.

(Supplementary Note 12)

The communication method according to any one of Supplementary Notes 9 through 11, wherein the source information is identified based on information obtained from the terminal and information on the packet, in a case that the source information is unable to be identified.

(Supplementary Note 13)

The communication method according to any one of Supplementary Notes 9 through 12, wherein the instruction is issued based on a rule for controlling the communication path that is determined in advance for respective pieces of the source information.

(Supplementary Note 14)

The communication method according to any one of Supplementary Notes 9 through 13, wherein a history of the communication path of the packet is saved.

(Supplementary Note 15)

The communication method according to any one of Supplementary Notes 9 through 14, wherein the source information is appended to a header section of the packet.
100 NETWORK SYSTEM
101 CONTROLLER
102 SWITCH 1
103 SWITCH 2
104 SWITCH 3
105 SHARED TERMINAL
106 BUSINESS SERVER
107 MANAGING TERMINAL
108 TERMINAL 1
109 TERMINAL 2
110 TERMINAL 3
111 IPS
201 SWITCH CONTROLLING UNIT
202 COMMUNICATION CONTROLLING UNIT
203 TERMINAL INFORMATION OBTAINING UNIT
204, 204-1, 204-2, 204-3 PATH INFORMATION MANAGEMENT TABLE
205, 205-1, 205-2 CONTROL RULE MANAGEMENT TABLE
206, 206-1, 206-2 USER INFORMATION MANAGEMENT TABLE
207, 207-1, 207-2 SESSION HISTORY MANAGEMENT TABLE
300 PACKET

The previous description of embodiments is provided to enable a person skilled in the art to make and use the present invention. Moreover, various modifications to these exemplary embodiments will be readily apparent to those skilled in the art, and the generic principles and specific examples defined herein may be applied to other embodiments without the use of inventive faculty. Therefore, the present invention is not intended to be limited to the exemplary embodiments described herein but is to be accorded the widest scope as defined by the limitations of the claims and equivalents.

Further, it is noted that the inventor's intent is to retain all equivalents of the claimed invention even if the claims are amended during prosecution.

1. A network system, comprising:
a switch for receiving a packet from a terminal, identifying source information of the packet, appending the source information to the packet based on an instruction, and transmitting the packet, to which the source information is appended, to a communication path based on the instruction; and
a controller for issuing the instruction to the switch.

2. The network system according to claim 1, wherein the source information is information for identifying at least one of a user name and an application name.

3. The network system according to claim 1, wherein the instruction includes an instruction for appending the source information to the packet and an instruction for specifying the communication path for respective pieces of the source information.

4. The network system according to claim 1, wherein the switch identifies the source information based on information on the packet, and requests the instruction as to the packet to the controller when the switch is unable to identify the source information.

5. The network system according to claim 1, wherein the controller identifies the source information from information obtained from the terminal and information on the packet.

6. The network system according to claim 1, wherein the controller issues the instruction based on a rule for controlling the communication path that is determined in advance for respective pieces of the source information.

7. The network system according to claim 1, wherein the switch transmits a history of the communication path of the packet to the controller, and the controller saves the history.

8. The network system according to claim 1, wherein the switch appends the source information to a header section of the packet.

9. A communication method, comprising:
identifying source information of a packet based on the packet received from a terminal;
appending the source information to the packet based on an instruction; and
transmitting the packet, to which the source information is appended, to a communication path based on the instruction.

10. The communication method according to claim 9, wherein the source information identifies at least one of a user name and an application name.
